(19) United States
(12) Patent Application Publication
(10) Pub. No.: US 2006/0226612 A1
(43) Pub. Date: Oct. 12, 2006

(54) Power trailer support structure an leveling system

(76) Inventors: Scott W. Smith, Palm Beach Gardens, FL (US); Stephen M. Jackson, Magnolia, TX (US); Brian D. Hulse, Harrells, NC (US)

Correspondence Address: WINSTON & STRAWN LLP, 1700 K STREET, N.W., WASHINGTON, DC, 20006, US

(21) Appl. No.: 11/074,945

(22) Filed: Mar. 9, 2005

Related U.S. Application Data
(60) Provisional application No. 60/551,030, filed on Mar. 9, 2004.

(51) Int. Cl. B60G 17/00

(52) U.S. Cl. 280/6.153; 280/423.1

(57) ABSTRACT

A power trailer support structure and leveling system continuously monitors the levelness a trailer containing the machinery train of a mobile power system. The invention can level the power trailer automatically while the gas turbine and electrical generator in the trailer are shut down, and can monitor and provide alarm and shut down protection when the gas turbine and electrical generator are operating. The invention includes a plurality of jacks and level sensors mounted to a power trailer, a programmable logic controller interconnected with the jacks and level sensors, and an interface for displaying jack positions and the output of the level sensors. A plurality of actuator mechanisms provide for automatic and manual control and a plurality of power systems between the actuator mechanisms and the jacks extend and retract the jacks in response to operation of the actuator mechanisms.

### CROSS-REFERENCE TO RELATED APPLICATIONS

This application claims the benefit of U.S. Provisional Application No. 60/551,030, filed Mar. 9, 2004, which is hereby incorporated by reference in its entirety.

### FIELD OF THE INVENTION

The invention relates to a leveling system for use with a vehicle, and more particularly, to a leveling system for a trailer-mounted mobile electrical power generation system.

### BACKGROUND OF THE INVENTION

Mobile power generation systems capable of delivering several or more megawatts of power have been known to offer certain advantages compared to power delivered from the electrical power or utility distribution grid. The mobile power generation systems can provide power as needed at times of peak demand or of brownout in the distribution grid, or in cases of need because of some emergency or other problem in the distribution grid as a result of a power grid failure or some other type of disaster. The mobile power generation systems also can be located at places distant from the distribution network where there is a need for power. There is then no need for the delay or expense of arranging for or construction of power lines to the distant or remote places. Some years ago, there were attempts made to provide electric power in trailer-mounted generator systems. An example of such a trailer mounted generator system is described in a magazine article entitled “Megawatts on Wheels” written by C. F. Thompson, C. R. Boland and E. Bernstein in the March 1971 issue of Combustion, pages 24-30. For various reasons, these types of generator systems did not, so far as is known, achieve any extended use and were not widely adopted.

As noted above, mobile power generation systems have certain desirable features and advantages. They have again recently become the subject of interest. However, there are a number of factors that give rise to problems with these earlier types of trailer mounted generator systems.

For optimum use, such a system needs to comply with weight and height restrictions from relevant highway regulatory and governmental agencies. Also, there are environmental limitations on the type and acceptable concentration levels of combustion waste products produced by this equipment. In addition, noise from the various components of the generator systems must be kept within presently established regulatory limits.

There were competing considerations regarding mobile power generation systems of this type. On the one hand, limits on weight and size of the systems had to be observed if the systems were to be highway transportable and thus available for widespread use. In conflict with this were the environmental and noise abatement considerations. Further, mobile power generation systems should be self-supporting in that they could bring to the site all equipment necessary to assemble the system in a relatively few days without the need for other equipment such as cranes, hoists and the like. It was felt by at least some that achieving suitable limits on combustion gas product emissions and noise levels could not be achieved while complying with height and weight limits for highway travel.

An example of a system that provides an improved mobile trailer-mounted power generation system is described in U.S. Pat. No. 6,786,051 to Kristich and Hulse, which is hereby incorporated by reference in its entirety. The mobile power system described there includes a gas generator burning a hydrocarbon fuel for creation of combustion gases that is operably interconnected with a free turbine that receives combustion gases and rotates a turbine shaft in response thereto. An electrical generator is mounted in communication with the free turbine for the generation of electricity upon rotation of the turbine shaft. A trailer body that is towable by a conventional tractor or truck is provided having a floor on which the gas generator, free turbine and electrical generator are mounted. The trailer body has end and side walls and a roof enclosing the gas generator, free turbine and electrical generator.

The trailer body is provided with an air inlet near one end for passage of air to the gas generator, and the free turbine has an exhaust for exit of the combustion gases. The trailer body has a combustion gas outlet formed in a side wall thereof for exit of the combustion gases from the free turbine. The gas generator, free turbine and electrical generator each have a longitudinal axis about which certain of their power generating components rotate during their operation. The longitudinal axes of the gas generator, free turbine and electrical generator are longitudinally aligned along a common axis along the longitudinal extent of the floor of the trailer body. This mobile trailer-mounted power generation system is easily connectable to other road transportable units that provide for removal of undesirable components of the combustion gases without increasing the height or width of the trailer body of the power generation system. The mobile, trailer-mounted power generation system permits modularization of components to achieve generation of electrical power from a road-transportable unit while complying with height and weight limits for highway travel and also meeting both noise and environmental requirements.

However, mobile power system machinery train components, especially the electrical generator, require precise alignment. The consequences of not having a level machinery train range from minor component damage to catastrophic failure. For example, the electrical generator has a set of babbited-type sleeve bearings. The bearings themselves have pressure-fed lubrication to them and gravity drain to an oil tank. Proper draining of the bearing cavities depends on the attitude of the machine in terms of pitch and yaw; if the machine is not kept within a certain boundary of levelness, the bearings will not drain properly. If the bearings do not drain properly, oil can accumulate and damage can occur in the bearings and also possibly to the actual shaft of the generator. Repair of this type of damage can take a significant amount of time. If the damage is severe enough, it may not be something that can be fixed on site or in the field; the repairs may have to be conducted at a repair shop away from the site. The damage can be very expensive, and if sustained while operating in an emergency generating situation, all electrical power generation capability may be lost. Thus, keeping these systems properly leveled and aligned is important.

Historically, the power generation industry has dealt with ensuring a level and aligned machinery train by using manual jacks, or possibly by supplying shimming pads on the bottom of the trailer chassis. Those systems require leveling by using piano wire or by using a transit on site or some other optical device to ensure that the system is level. Use of such techniques are normally beyond the capability of power plant operators. Operators do not normally work with that type of hardware and they are not usually familiar with it. Thus, there has been a requirement to have some level of specialized expertise in checking that the system is level. Additionally, this checking has to be done on a relatively frequent basis to ensure that as the system operates and vibration occurs in the system, and also thermal expansion and contraction occurs, that the system once leveled, stays level and does not fall out of level. Depending on the condition of the site soil, how much compaction has been done, and the design of any of the jack pad load spreaders that come with equipment, this rechecking of the system to make sure that it is level could be a very frequent operation; as much as daily or perhaps even several times during a day. This results in the need to keep specialized equipment and people available on site.

Most of mobile power generation sites require civil improvements, e.g., concrete pads, major soil rework, installation of geomat, to a site prior to bringing mobile generation systems in. Some systems require laying down sheets of 1″ steel for the unit to sit on. This has been needed because the system vibrates and acts as a soil compactor. As the soil compacts, the unit falls out of level and must be adjusted. Because these systems have used manual jacks and optical check devices, this is a major inconvenience.

Accordingly, a need exists for a more flexible system that can continuously monitor the levelness of a trailer containing the machinery train of a mobile power system and automate the process of leveling such a trailer when needed. By installing such a system on the trailer, the need for specialized equipment and extra people to operate that equipment is negated.

### SUMMARY OF THE INVENTION

The present invention is directed to a new and improved mobile power trailer support structure and leveling system that satisfies this need.

One embodiment of the present invention includes a plurality of extendable and retractable jacks mounted to a power trailer, a plurality of level sensors mounted to the power trailer, a programmable logic controller interconnected with the level sensors and jacks, and an interface for displaying jack positions and the output of the level sensors. One embodiment further includes a plurality of actuator mechanisms for automatic and manual control, including a plurality of switches, and a plurality of power systems between the actuator mechanisms and the jacks for extending and retracting the jacks in response to operation of the automatic or manual actuator mechanisms to adjust the attitude of the power trailer relative to level.

In one embodiment, the jacks can be worm-screw jacks. The shafts of the jacks may be made of stainless steel. The power systems for extending and retracting the jacks in one embodiment can be direct current electrical motors. Alternatively, the power systems can be alternating current electrical motors or hydraulic rams.

Another embodiment can be a method of operating a power trailer support structure and leveling system. The method includes initiating a leveling sequence by selecting at least one of a plurality of switches controlling at least one of a plurality of actuator mechanisms that extend or retract each jack. The method further includes extending or retracting at least one of the jacks to a load pad and determining the attitude of the trailer. Next, at least one of the jacks may be extended or retracted to bring the trailer to a level attitude. The method then calls for extending or retracting at least one of the jacks to reduce sag in the center of the trailer.

### BRIEF DESCRIPTION OF THE DRAWINGS

These and other features, aspects and advantages of the present invention will become better understood with regard to the following description, appended claims and accompanying drawings where:

FIG. 1 shows an example of a top plan and side elevation view of one embodiment of the power trailer according to the present invention.

FIG. 2 shows an example of a top plan view of one embodiment of a control trailer according to the present invention.

FIG. 3 shows an example of a view of the interface for displaying jack positions and the output of the level sensors and controls for the leveling system in one embodiment of the present invention.

FIG. 4 shows an example of a side elevation sectional view of one embodiment of the jacks according to one embodiment of the present invention.

FIG. 5 shows an example of a top plan sectional view of one embodiment of the jacks according to one embodiment of the present invention.

FIG. 6 shows an example of a side elevation view of one embodiment of the power trailer according to the present invention.

FIG. 7 shows an example of an elevation view of one embodiment of hydraulically operated outrigger extension beams according to the present invention.

FIG. 8 shows an example of an elevation view of one embodiment of manually operated outrigger extension beams according to the present invention.

### DETAILED DESCRIPTION OF THE INVENTION

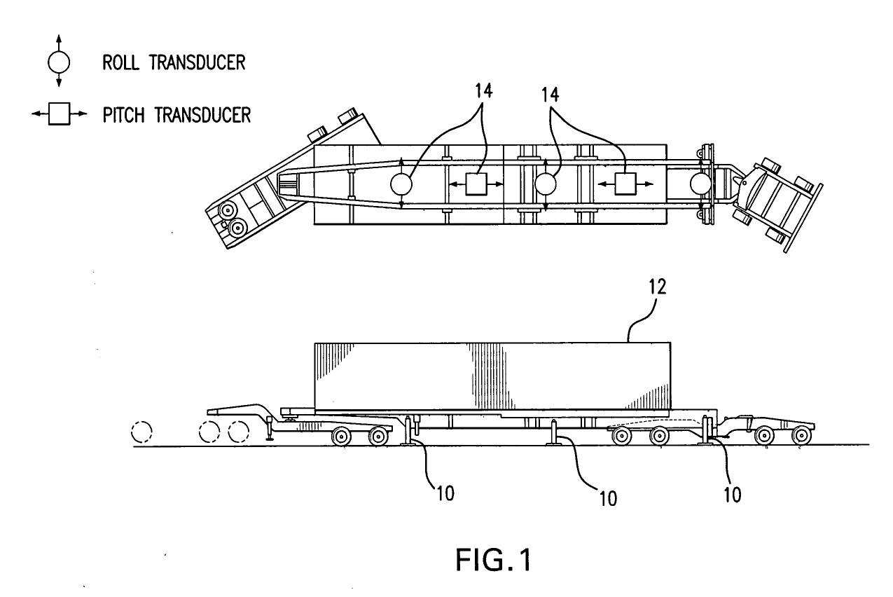

FIG. 1 shows an example of one embodiment of the power trailer support structure and leveling system. In FIG. 1, a mobile power trailer support structure and leveling system comprises a plurality of extendable and retractable jacks 10 mounted to a power trailer 12. Also mounted to the power trailer 12 are a plurality of level sensors 14.

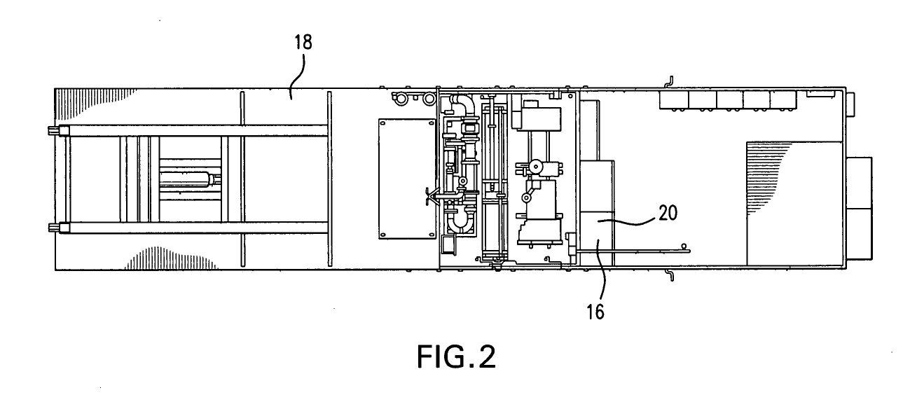

FIG. 2 shows an example of the location of a programmable logic controller (PLC) 16, which may be in a control trailer 18. The PLC 16 may be interconnected with the level sensors 14 and jacks 10. In one embodiment, an interface 20 provides for display of system parameters and control of system functions.

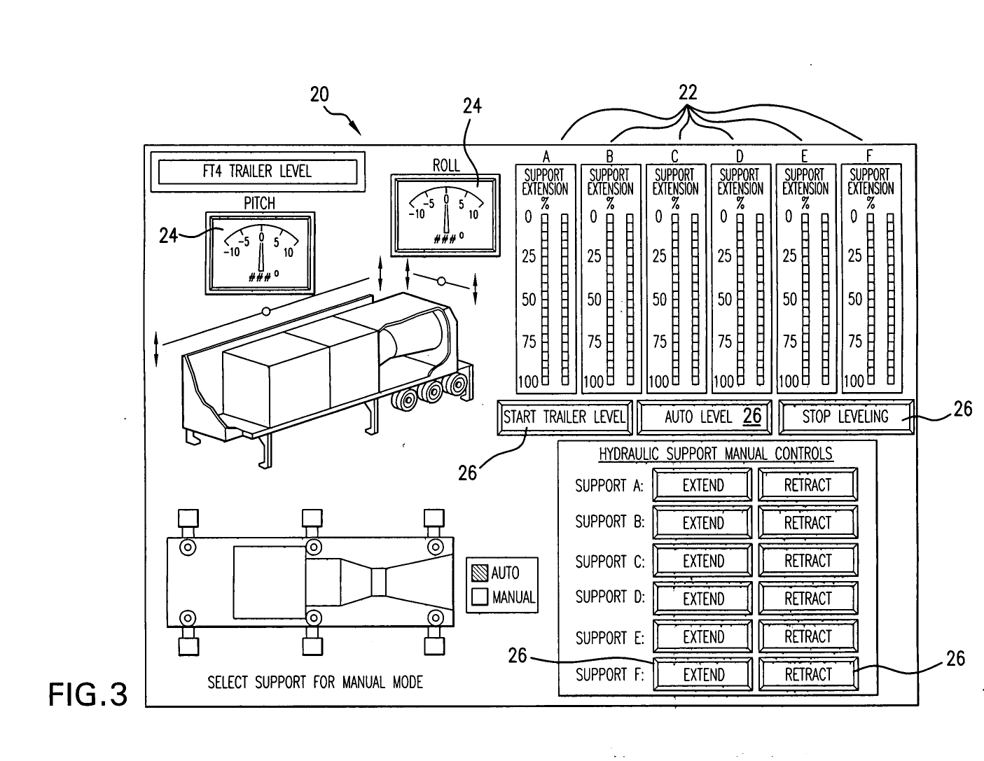

FIG. 3 shows an example of a closer view of an embodiment of interface 20. This embodiment includes displays 22 for jack 10 positions, displays 24 for the output of the level sensors 14, and a plurality of switches 26 for automatic and manual control.

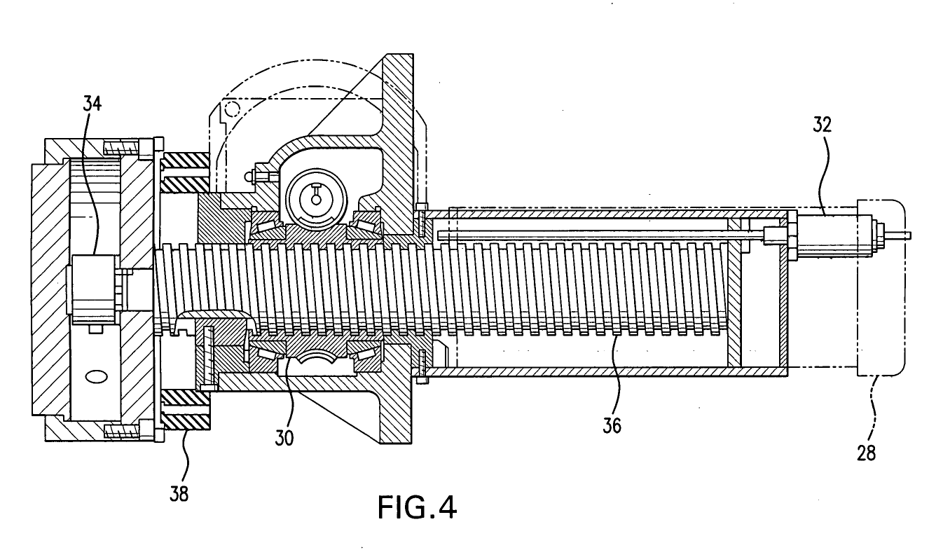

FIG. 4 shows an example of one embodiment of a worm-screw jack 10 that may be operated by a DC current motor 28. Jacks 10 can maintain a position with weight on it without having a motor or a pump running. Jack 10 may consume power when worm gear 30 is being moved. However, when worm gear 30 is not being moved, jack 10 may not consume power and may not be a load on the system.

Jack 10 may also have a linear variable displacement transducer 32 that may tell the operator of the control system where in the stroke the jack 10 is, i.e., what the position of jack 10 may be at any given time within its stroke. Jack 10 may also have a strain gauge device 34 at the bottom of jack 10 that provides feedback on how much weight jack 10 may be picking up at any given time.

In one embodiment, jack 10 may be part of a six-jack system, i.e., three per side of the power trailer 12. Each jack 10 can be capable of lifting 70,000 pounds. The total gross weight of one embodiment of the trailer system can be 175,000 pounds total, thus the jacks 10 in this embodiment are capable of lifting this load.

The jacks 10 can include a stainless steel jackshaft 36. This material may be preferable to carbon steel and may limit corrosion during transport and while this unit may be sitting at a site for long periods with a considerable amount of the jackscrew 36 being exposed. Additionally, expanding boots 38 may be installed around the exposed stainless steel jackshaft 36 to help protect it and the components of jack 10 against corrosion in an effort to extend the life of the hardware.

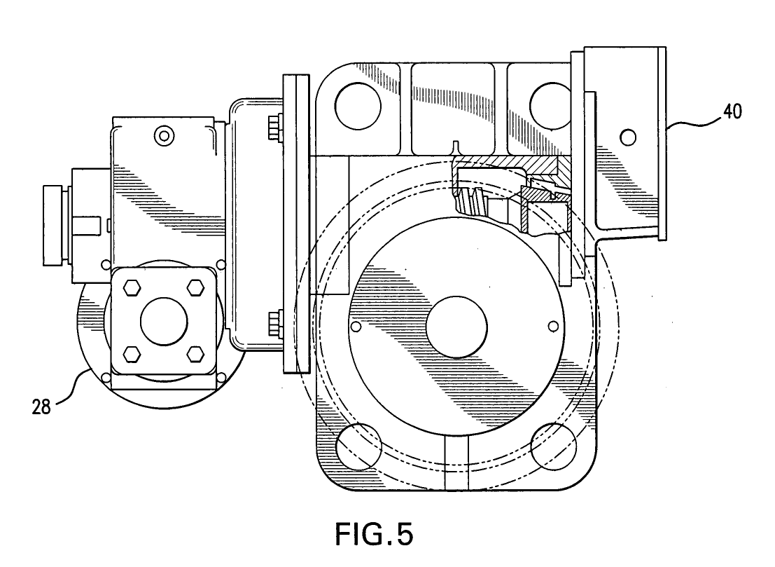

FIG. 5 shows an example of a top view of a jack 10 that may also include upper and lower limit switches 40 to tell when jack 10 has reached its travel limits.

Each jack 10 may be bolted directly to the chassis of the trailer 12. Jack 10 mounting pads may be installed to the trailer 12 chassis at specific lifting points. Each jack 10 may have a number of wires for signals related to control and indication as well as for supplying power to the DC motor 28. The attachment of each jack 10 to the trailer 12 chassis may be preferable as a bolted fitment rather than welding or some other more permanent methodology of fitting the jacks 10 to the chassis. There may be situations in transportation of the unit where the jacks 10 may need to be removed in transportation to keep the trailer 12 system from contacting the road, for instance when the trailer goes across a railroad track or some other high spot in the road. Thus, if there may be a clearance problem caused by the jacks 10 themselves, the jacks 10 can be unbolted and physically removed from the trailer 12 chassis. Wiring associated with the jacks 10 may be removed from junction boxes and this provides additional ground clearance for the trailer 12 system and allows the trailer to be transported across potential obstacles.

As mentioned, the jack motors 28 may be direct current motors. Those particular motors offer several advantages. They allow jacking of the trailer 12 when there may be no AC power being supplied from the mobile power generation system or being brought into the system from an outside source. This may allow the trailer 12 to be leveled when it initially arrives on a site without the benefit of power from another source. Leveling may be accomplished with a set of batteries that may be located on the control trailer 18 and the system may be able to go through the leveling sequence on battery power alone, and the trailer may be leveled that way. Also, the motors 28 that may be selected in one embodiment can be totally enclosed fan-cooled motors. These motors may be selected to provide a weatherproof feature on the jacks 10, to make sure that water reaching the motors 28 may be minimized during transportation or service in the field. This may allow for greater reliability in the operation of the motors 28 operation.

A motorized worm gear type jack may be preferable over hydraulics because hydraulics usually requires a pump and motor running to maintain the position of a jack. A check valve and other devices that are normally used to stop flow in a hydraulic system do not seal completely enough to be able to hold a position with weight on it without having to continuously provide hydraulic pressure to compensate for any leak by. Hydraulics are an alternative if the system can sustain a pump and motor on all the time to provide make-up hydraulic pressure. One disadvantage might be that having that system running may be an additional parasitic load on the power generation system and the desire is normally to have all of the power being generated, or as much of it as possible, go to the power grid or to an individual user. Thus, a reduction of parasitic load may be something to consider and the ability to take a parasitic load out of the system may drive the selection of worm gear jacks.

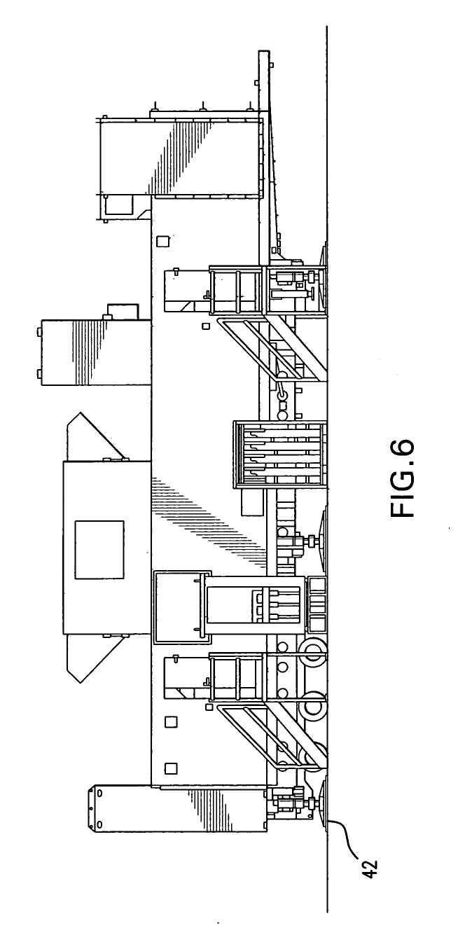

Referring to an example in FIG. 6, each jack 10 may be provided with a jack pad 42. The jack pads 42 may be made of aluminum. Alternatively, they may be stainless steel. In one embodiment, the six jack pads 42 provided with the system may be designed to spread the load from the foot of the jacks in such a manner that the total load the system puts on the ground does not exceed 1000 pounds per square foot. That specification may normally be used in many switchyards in North America. Since the unit may be designed to be an emergency generation device or a backup generation device, the desire may be to have it capable of being deployed into relatively undeveloped locations in terms of site preparation. By using load spreading devices such as jack pads 42, the load may be spread out over a large area, and therefore foundations or special site preparation beyond what would normally be found in a switch yard in North America may not be required. Because of the length of the system, it may be preferable that there be no more than one inch of grade deviation over a 30-foot run. This may provide that the stroke of the jack may be capable of taking out any unevenness that may be encountered in the site after that preparation may be accomplished. With that set of pre-existing conditions and the automated jacking system to monitor and maintain the attitude of the trailer, the operations group running an exemplary unit may have fewer out-of-level events and, when they do occur, they may be dealt with more efficiently than they could be with existing equipment.

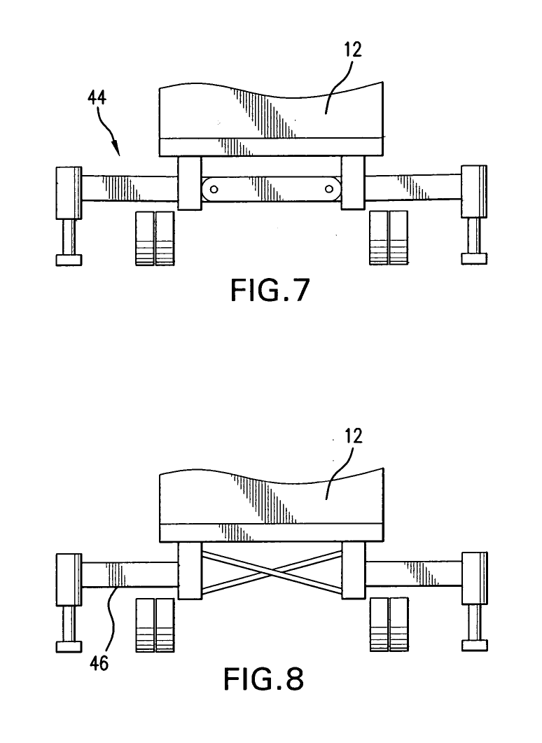

FIG. 7 shows an example of a trailer 12 configured with jacks 10 that may be mounted to powered outriggers 44. In one embodiment, the power for extending and retracting the outriggers may be hydraulic power. In one embodiment, these hydraulically-operated outriggers 44 may retract for storage and transport and extend for unit operation.

FIG. 8 shows an example of a trailer 12 configured with an arrangement where the extension beams 46 may be fastened to a trailer 12 chassis and the chassis may be reinforced to support side loading. Suitable fasteners may include bolts.

By using a jacking system that includes outriggers, the base of the unit may be effectively increased. A full-load fault current suffered by an electrical generator could be sufficient to roll the trailer 12 on its side. This could be a danger to personnel as well as surrounding support equipment. Thus, adding outriggers may reduce the risk of trailer 12 rolling on its side and could allow for the use of a larger generator.

In one embodiment, referring back to an example in FIG. 1, five level (pitch and yaw) sensors 14 may be located on the underside of the trailer 12 chassis, along the centerline. A suitable sensor can be a precision 4 to 20 mA angle measurement sensor supplied by Cline Labs, Inc. This sensor uses a standard ratiometric sensor, and adds a conversion circuit board to give an accurate and versatile four-wire 4 to 20 mA sensor. In addition to the 4-20 mA feedback, only a 24V DC supply may be. required by the unit. The unit also features indication of correct installation by use of two indicators LEDs that light when in true horizontal level state—no further equipment may be needed. The red and green LEDs will switch at the 12 mA position within 0.3 mA; this indicates that the sensor may be level. The output range may also be selectable to allow high accuracy over the expected range of movement.

The sensors 14 may be mounted within a small heavy-duty watertight junction box. In one embodiment, two sensors 14 (one transducer for each plane) may be mounted on cross members of the power trailer 12 close to the center point.

These sensors 14 generate signals to show the attitude of the trailer 12 and they may transmit these signals through wires to an electrical connection cabinet in the power trailer 12. From the electrical connection cabinet, the information may be transmitted through coaxial cable to the turbine control panel 16 where it may be brought into a control system and used to run the leveling system. Each of the sensors 14 may be set at the factory and positioned so that there may be a good correlation of the instruments to the trailer 12 chassis. One reason that multiple sensors 14 are used in one embodiment may be that the sensor's 14 accuracy falls off over distance, so to ensure that the accuracy of the measurements that the indication and control system may be receiving is adequate to maintain the levelness of the trailer 12 chassis, readings from multiple sensors 14 may be used. The sensors 14 may be located on specific pads that have been welded into the framework of the trailer 12. These pads may be welded as accurately as possible to reflect the parallelism and flatness of the two main longitudinal trailer 12 chassis structural elements. Beyond the accurate positioning of the pads, there may be internal adjustments in the sensor 14 housings to correct for any minor inconsistencies that may be encountered with the pads.

Regarding a control system, one suitable system that may be used may be provided by Rockwell Automation. In one embodiment, instrumentation on the jacks 10 and the level sensors 14 output, as well as the power that powers those instrumentation devices, passes through an electrical connection cabinet that may be in the power trailer 12. The electrical communication cabinet may work to communicate the information from the instrumentation devices to the turbine control cabinet where a programmable logic controller (PLC) 16 may exist. Within the PLC 16 may be a set of software subroutines that are capable of processing the output of the level sensors 14 and determining whether the readings are within a set of preprogrammed limits that may be set in the PLC 16 at the factory. The limits that may be programmed into the PLC 16 are extensions of the limits on angular position that are accepted by the various equipment manufacturers of the main machinery train, i.e., the gas generator, free turbine and the AC generator in the power trailer 12. Each of these machines may have limitations in terms of the amount of out-of-level they can accept and still run properly. The limitations that are given by the manufacturer should not be exceeded, so within the PLC 16 that may be monitoring the levelness of the trailer 12, limits are programmed that are less than the actual limits set by the equipment manufacturers. The level sensors 14 may send signals to the PLC 16 and those signals may be compared with the programmed limits. In one embodiment, when a certain out-of-level condition exists, an alarm can sound to signal an operator that the system may be going out-of-level and action should be taken to correct the situation. If the situation is not corrected, or if the deterioration of levelness is too rapid, there may be a second level of limits that may be reached. When those limits are reached, the system may be brought off line and not restarted until the out-of-level condition is corrected.

In one embodiment, there may be a software subroutine in the PLC 16 system that checks the level sensors 14 and then sends signals to articulate the jacks 10 in order to correct the out-of-level condition. The system may continue to strive to achieve a level situation until either leveling has been accomplished or until one of the jack limitations has been met, i.e., a jack 10 has extended or retracted to its limit switches. Once a jack has reached a limit, the subroutine may stop and go no further. Here, the out-of-level condition may not be corrected so the unit cannot be started until the overall condition has been remedied. This may take an operator to investigate a problem and might require additional cribbing underneath a jack pad if a jack 10 may be at the bottom of the stroke. If a jack 10 may be at the top of a stroke, it may be that the entire unit requires re-leveling.

In one embodiment, the PLC 16 system may continuously monitor the level sensors 14 any time PLC 16 system may be on, and it will give an indication as to whether the system may be ready to start, may be running acceptably, or if there may be an alarm situation. In one embodiment, there may be an alarm display on the front of the turbine control panel on an interface 20. Interface 20 may be a video screen, and an alarm could alert an operator that there may be a problem with the system.

In one embodiment, there may be cabling and termination boxes and junction boxes throughout the system to enable troubleshooting and to facilitate assembling the system. The wiring and the junction boxes may be marked to facilitate maintenance and troubleshooting. There may also be a significant amount of attaching hardware, e.g., for attaching the jacks to the trailer system. This hardware may include nuts, bolts, and other fasteners and adapter brackets that are used to adapt the jacks 10 to the trailer 12 chassis. The attaching hardware, wiring and junction boxes may be assembled at the factory. The hardware and wiring may be selected for transmitting the signals, providing the power and managing the weight of the trailer itself.

Overview of Levelinq Sequence

Prior to mobile power system operation, machinery train components prefer to rest on a true horizontal plane. This helps ensure stable, concentric operation of the rotating machinery and prevents premature wear of hardware, in addition to minimizing unscheduled maintenance requirements.

With the turbine at a stopped or ready to run state, the operator may, via the interface 20, initiate a trailer auto leveling sequence. Alternatively, the operator may, from the interface 20, take manual control of trailer leveling. By selecting manual control on any one of the available supports, a manual mode may be entered. In this mode, each support can be extended or retracted as desired.

In one embodiment, the power trailer 12 may be mounted on six worm-screw jacks 10 that are capable of sustaining the entire weight of the unit. These jacks 10 can be individually extended and retracted to orientate the power trailer to a level state. This true horizontal plane, and the trailer's 12 deviation from it, may be monitored by level sensors 14 independently measuring the trailer's 12 pitch and roll.

In one exemplary embodiment, for the jacks 10 to be extended or retracted, DC power may be available for the motors 28 on the jacks 10. An operator may then view a trailer-leveling screen on the interface 20 and verifies that the system may be in automatic control. The operator may then initiates the sequence by selecting AUTO LEVEL. All six jacks 10 may drop to the jack pads 42 and may pick up a pre-programmed weight, and then stop. The PLC 16 may then poll the pitch and roll sensors 14 to determine the attitude of the trailer 12. If the trailer 12 is not level, the PLC 16 may actuate the outboard four jacks 10 to bring the trailer 12 into a level attitude, allowing for a pre-programmed center sag. Once the trailer 12 may be level, the PLC 16 may use the inboard two jacks 10 to reduce any center sag. During jack 10 movement, the PLC 16 may monitor the weight each jack 10 lifts and stroke position to ensure the each jack 10 may not be overloaded or too close to the end of a stroke.

In one exemplary embodiment, the PLC 16 may monitor the level sensors 14. Should the trailer 12 move to a pre-determined out-of-level condition, the operator may receive an alarm from the PLC 16. If the trailer 12 continues to move and reaches a second pre-determined out-of-level condition, the PLC 16 may issue a NORMAL STOP command. Restart of the system may not be possible until the trailer is re-leveled.

In another embodiment, there may be four supports at the four corners of the electrical generator, along with level sensors mounted beneath the generator. A plurality of legs may be used to support the remainder of the trailer 12.

In one embodiment, achieving a level condition of the electrical generator may be sufficient since sag in the structure under the electrical generator may be negligible due to the placement of supports under the electrical generator and by using short beam length between supports. Level sensing may be accurate with level sensor locations centered between the supports.

In one embodiment, a method could include placing four inner supports to level the electrical generator. A next step could include placing a plurality of outer supports to achieve a predefined load sharing of the weight of the power trailer 12. Supports could be extended to achieve load sharing by all supports, which could be sensed with load cells.

In one embodiment, sensing the attitude the remainder of the trailer 12 (outside of the electrical generator mount area) in addition to sensing the attitude of the electrical generator mount area may also be accomplished.

Although the present invention has been described in considerable detail, other alternative versions are possible. Therefore, the spirit and scope of the appended claims should not be limited to the description of the versions contained herein.

What is claimed is:

1. A support structure and leveling system comprising:
a plurality of extendable and retractable jacks mounted to a structure;
a plurality of level sensors mounted to the structure;
a programmable logic controller interconnected with the level sensors and jacks;
an interface for displaying jack positions and the output of the level sensors;
a plurality of actuator mechanisms for automatic and manual control, including a plurality of switches; and
a plurality of power systems between the actuator mechanisms and the jacks for extending and retracting the jacks in response to operation of the automatic or manual actuator mechanisms to adjust the attitude of the structure relative to level.

2. The support structure and leveling system of claim 1 wherein the jacks are worm-screw jacks.

3. The support structure and leveling system of claim 2 wherein the jacks have stainless steel jackshafts.

4. The support structure and leveling system of claim 3 wherein the power systems are direct current electrical motors.

5. The support structure and leveling system of claim 3 wherein the power systems are alternating current electrical motors.

6. The support structure and leveling system of claim 1 wherein the power systems are hydraulic rams.

7. A method of operating a support structure and leveling system, wherein a plurality of extendable and retractable jacks are mounted to a structure and wherein the jacks are movable in response to the operation of a plurality of actuator mechanisms for automatic or manual control, comprising the steps of:
initiating a leveling sequence by selecting at least one of a plurality of switches controlling at least one of a plurality of actuator mechanisms that extend or retract each jack;
extending or retracting at least one of the jacks to a pad;
determining the attitude of the trailer;
extending or retracting at least one of the jacks to bring the structure to a level attitude; and
extending or retracting at least one of the jacks to reduce sag in the center of the structure.
